(19) United States
(12) Patent Application Publication
(10) Pub. No.: US 2015/0170534 A1
(43) Pub. Date: Jun. 18, 2015

(54) Learning Management Systems and Methods

(71) Applicant: Brian Leach, Richmond, VA (US)

(72) Inventor: Brian Leach, Richmond, VA (US)

(73) Assignee: Unboxed Technology

(21) Appl. No.: 14/568,720

(22) Filed: Dec. 12, 2014

Related U.S. Application Data
(60) Provisional application No. 61/915,156, filed on Dec. 12, 2013.

(51) Int. Cl. G09B 5/10; H04L 29/08; H04L 29/06

(52) U.S. Cl. CPC G09B 5/10; H04L 63/105; H04L 67/10

(57) ABSTRACT

The present invention encompasses a computer implemented LMS that allows learners to securely login and obtain access to online training courses, community message boards, a library of resources (documents, videos, audio, etc.) and robust analytics and reporting.

### BACKGROUND OF THE INVENTION

Traditional Learning Management Systems (LMS) platforms present learning materials in the context of mandatory curriculums built at the corporate administrator level. Because interacting with content is mandatory in traditional LMS platforms, these platforms typically place little to no focus on creating an intuitive or engaging user interface (UI).

Forward-thinking companies need a communication platform to allow geographically disparate employees and third-party reps to complete training on the go and share knowledge with one another. Traditional Learning Management Systems suffer from complicated interfaces, expensive per-user fees, and a lack of mobile optimization.

### SUMMARY OF THE INVENTION

The present invention is directed to systems and methods for providing learning materials to users.

The present invention integrates mandatory training content with socially created training. The present invention uses a highly visual approach to presenting learning materials, using mobile-friendly graphical panels to represent courses and other resources. When using the present invention, learners are enticed to engage with community-driven content which leads to increased usage and greater retention of materials.

Embodiments of the present invention encompass a computer implemented LMS that allows learners to securely login and obtain access to online training courses, community message boards, a library of resources (documents, videos, audio, etc.) and robust analytics and reporting.

Embodiments of the present invention also encompass a cloud-based LMS that allows learners to securely login and obtain access to online training courses, community message boards, a library of resources (documents, videos, audio, etc.) and robust analytics and reporting.

Further embodiments of the present invention contemplate a computer implemented system comprising: a server; a community of system users; one or more user computers comprising an engaging user interface; virtual performance incentives; mandatory training content; and socially created training content.

The present invention also contemplates system for providing to a community of users access to training content comprising a plurality of user computers, with each user computer being associated with a user of the system and with each user and comprising and engaging user interface and a server in communication with each of the user computers over a network, the server computer comprising means for storing a plurality of data files associated with mandatory training content; a means for storing a plurality of data files associated with community created content; means for determining whether access to a data file associated with the course is authorized; means for allowing access to and control of the data file associated with the course if authorization is granted based on the access level of the user of the system; wherein the server is configured to accept community created content and accept user interactions with community created content and wherein the server is further configure to provide virtual rewards to users that interact with mandatory training content and/or community created content.

Embodiments of the present invention also encompass a Turnkey Toolkit that includes the aforementioned LMS as part of a larger platform of integrated systems. The LMS can share data (e.g., point or “coins” earned) with these integrated systems in order to allow a company to track and encourage employee performance across multiple facets of the employee's job.

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

Traditional LMS platforms present learning materials in the context of mandatory curriculums built at the corporate administrator level. Spoke is unique because it integrates mandatory training content with socially created training content and comments. Rather than present only corporate-provided training content, the present invention presents all of the training content—both mandatory corporate content and community created content to provide the most accurate and complete training experience. This may consist of content created by the community including message board content written by peers and content that is uploaded and shared via video or pictures. Learners can mark valuable content as “helpful” and can also sort learning materials according to the number of “helpful” marks they have received from peers. This further differentiates the present invention by allowing the most valuable content to rise to the top of the page. The present invention allows the community of learners, rather than a pre-assigned corporate curriculum, to determine what content is most valuable.

Because interacting with mandatory training content is mandatory in traditional LMS platforms, these platforms typically place little to no focus on creating an intuitive or engaging user interface (UI). In contrast, the present invention takes a highly visual approach to presenting learning materials, using mobile-friendly graphical panels to represent courses and other resources. Learners are enticed to engage with the present invention's community-driven content which leads to increased usage and greater retention of materials.

Because interacting with mandatory training content is mandatory in traditional LMS platforms, these platforms place little to no focus on providing performance incentives to learners. In contrast, the present invention allows learners to earn “coins” for completing courses and for posting user-generated content that is deemed helpful by the community at large. These coins allow learners to earn new levels/ranks in Spoke, and the coins can be exchanged for tangible rewards when the present invention is paired with a fulfillment partner.

Traditional LMS platforms are limited in scope to only track learner performance as it pertains to course completion. The present invention integrates with other systems as part of a larger Turnkey Toolkit, allowing companies to track employee performance from completing courses to demonstrating learned skills on the job.

The present invention provides:
A simple user experience to take courses that are mobile friendly
A community of learning and best practice sharing
One location for tools and resources that help you do your job
A fun and tangible method for rewarding performance and participation
The ability to integrate with additional systems to allow a company to track and encourage employee performance across multiple facets of the employee's job.

### Overview

The present invention is a lightweight alternative to the traditional Learning Management System, focused on social integration and mobile optimization, and marketed to companies. When a company employee (“learner”) logs into the present invention using company-provided credentials, he has access to training courses, community message boards, and a library of resources (documents, videos, etc.) that help him learn how to do his job.

### User Interface

Within the present invention, the learner sees available courses and resources represented as highly visual panels, which display a large image that represents the course, links to discuss the course with peers on the community message boards, and a launch button that allows the learner to begin the course. If the learner needs to exit a course before finishing it (highly likely given the present invention's mobile nature), he has the ability to resume his progress where he left off.

The learner also has access to community message boards, which allow him to discuss company-related topics with peers. On the community message boards, the learner can read comments from peers, reply to comments, post original comments, and upload documents. The message boards are grouped into categories for easy browsing. Some message boards are associated with, and linked from, particular courses, to allow learners to easily discuss a course in one place.

By passing assigned courses and by posting helpful comments on the community message boards, a learner earns “coins” that allow him to progress through a hierarchy of “levels.” Courses have a coin value determined by an algorithm that is based on the size of the company. If a learner posts a comment on the community message board that a peer finds helpful, that peer can award a coin to the learner as well. Finally, by achieving certain platform thresholds (e.g., passing enough courses, posting enough helpful comments), the learner can earn visual “badges” to display on his profile as marks of achievement. Coins, levels, and badges are all visible to the learner's peers. In addition, each learner can-see where he stands relative to his peers in terms of coin progress, at each level of geographic hierarchy in the company (e.g., location, district, region).

Upon login, the learner lands on a Dashboard page, which aggregates the most important information from throughout Spoke into a single place. The Dashboard contains a snapshot of the user's profile, the next few sequential courses in the learner's curriculum, the latest discussions from the community message boards, and the top-ranked resources, as determined by awarding of coins by users.

When integrated with additional systems as part of the Turnkey Toolkit, Spoke includes an interface that allows a user to navigate between all integrated systems with a single set of login credentials. The learner's data is shared between systems to provide for a consistent user experience.

### Administrative Portal

The training courses that a learner sees are controlled by his login credentials, and set by an administrator at the corporate level using an Administrative Portal. Within the Administrative Portal, the administrator assigns training courses into course packs, course packs into curriculums, and curriculums to learners. In this way, the administrator ensures that all learners receive the training courses relevant to their role in the organization. Within the Administrative Portal, the administrator also assigns learners to company locations, districts, regions, etc. in order to enable the company to run reports on geographic training compliance.

### Technical

The present invention may be built as a responsive website, meaning it automatically resizes its content to fit the dimensions of a user's viewing device. Because the present invention is built with HTML, CSS, and JavaScript, it is compatible with both computers and mobile devices (iPad, iPhone, Android devices).

The User Dashboard shows where the user stands, the leaderboard, the next courses to be completed, recent discussions, and top resources.

The user can see how many coins they have collected, courses they have completed, helpful votes their comments have received from the community, and badges collected for participation. Users increase levels as they earn coins for course completion and community participation.

Administrators can upload SCORM-compliant training courses and create course packs to manage curriculums by job role. Course packs allow Administrators to organize a collection of courses by topic to support a progressive learning path. Each course is elegantly organized with a thumbnail, course description, length and recent discussions from users.

The Community allows users to share knowledge and best practices. Administrators define topics to organize conversations and engage social learning. Users award coins to the most helpful comments, ensuring that best practices are highly visible and rise to the top. The present invention includes filters to remove inappropriate words and moderators can manage user comments.

The present invention allows an Administrator to manage a library of helpful resources, such as Word, Excel, PowerPoint documents, PDFs and videos. Users rank the most helpful resources so they rise to the top, ensuring the most valuable content is always highly visible.

The present invention uses gamification to encourage learner engagement. Learners earn coins, levels, and badges that signify progress, credibility, and certification amongst peers.

The present invention's responsive design automatically resizes to fit the user's device, from desktop to tablet to phone (iOS and Android).

The present invention supports federated login and single sign-on (SSO) with company employee databases, to allow employees to access Spoke using existing company-provided identifying credentials (e.g., username and password).

The present invention allows users designated as managers to run reports on metrics like training sessions and pass rate. The present invention identifies the manager's placement in the organization according to his or her login credentials, and shows the manager only that data which he or she has clearance to view. The manager can roll data up by learner, district, and region, or export to Excel for further analysis.

Reports include:
Resource library usage
Community usage, including comments posted and helpful coins awarded
Platform logins
Time spent training
Course performance—User pass & fail rate, users assigned, user progress
A complete course transcript for each learner

The present invention's initial configuration includes turnkey implementation support.
A custom designed skin to match your brand
Upload of your users
Creation of locations, districts, regions, etc. to reflect the company's organizational hierarchy
Creation of Job Codes to reflect the company's employee roles
Upload of your SCORM-compliant courses
Set up and organize course packs and curriculums
Assign course packs and curriculums by job role
Upload your resource documents
Create thumbnail images for courses and resources
Establish coin values for passing courses based on a proprietary algorithm
Set up your database and server configuration including, SSL security configuration, load balancing and redundancy.

In general, the present invention features:
Simple, usable interface
Basic color/logo skinning
Personalized dashboard for users
Optimization for use on computer, tablet, & phone
Transparent, tier-based pricing model
SSL security encryption

Course and Resource Administration
Upload courses from Articulate/Captivate (.SWF, .HTML5)
Publish/delete courses
Add/delete users
Set access and permissions by user's job title
Set required courses by user's job title
Define passing score for courses
SCORM 1.2 compliant
Stage courses/resources before publishing
Upload resources (.PDF, .MOV, .PPTX, .DOCX)
Organize resources into categories
Bookmark course progress and resume later
Discuss a course with peers

Social Learning
Users can post messages
Users can “upvote” valuable content by awarding coins
Users can sort content by coins awarded to easily find the most valuable content
Users can tag discussions with key words to allow users to easily find related discussion
Users can search for content by key words
Users can upload images and documents
Users earn coins for passing courses and posting valuable content
Users earn titles based on coins accrual (e.g., “Greenhorn,” “Ninja,” “Samurai”)
Users earn badges to display on their profiles
Users receive email notifications when someone replies to their comments
Administrators can “pin” valuable discussions to the top of a page for increased visibility to learners

Reports
Filter metrics by region, district, location, etc.
Export all data to Excel for analysis
Resource library usage
Community usage, including comments posted and helpful coins awarded
Platform logins
Time spent training
Course performance—User pass & fail rate, users assigned, user progress
A complete course transcript for each learner

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of compositions and processes would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A computer implemented system comprising:
a server;
a community of system users;
one or more user computers comprising an engaging user interface;
virtual performance incentives;
mandatory training content; and
socially created training content.

2. The computer implemented system of claim 1, wherein the community created training content comprises message board content.

3. The computer implemented system of claim 1, wherein the community created content comprises uploaded content.

4. The computer implemented system of claim 1, wherein the server is configured to allow the community of users to interact with the community created training content.

5. The computer implemented system of claim 1, wherein a virtual performance incentive is provided to a member of the community of users for posting socially created content.

6. The computer implemented system of claim 1, wherein a virtual performance incentive can be exchanged for a tangible reward.

7. The computer implemented system of claim 1, wherein the mandatory training content is arranged in a hierarchy.

8. The computer implemented system of claim 7, wherein earning a virtual performance incentive allows a user to be ranked in the mandatory training content hierarchy.

9. The computer implemented system of claim 1, wherein the community of system users are able to interact with each other.

10. A system for providing to a community of users access to training content comprising:
a) a plurality of user computers, with each user computer being associated with a user of the system and with each user and comprising and engaging user interface and
b) a server in communication with each of the user computers over a network, the server computer comprising: means for storing a plurality of data files associated with mandatory training content; a means for storing a plurality of data files associated with community created content; means for determining whether access to a data file associated with the course is authorized; means for allowing access to and control of the data file associated with the course if authorization is granted based on the access level of the user of the system;
wherein the server is configured to accept community created content and accept user interactions with community created content and wherein the server is further configure to provide virtual rewards to users that interact with mandatory training content and/or community created content.
